(19) United States
(12) Patent Application Publication
(10) Pub. No.: US 2002/0109647 A1
(43) Pub. Date: Aug. 15, 2002

(54) Communications system for airplane passengers

(76) Inventors: John C. Crandall, Fort Collins, CO (US); Michael L. Rudd, Fort Collins, CO (US); Jerlyn R. Culp, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/784,727

(22) Filed: Feb. 15, 2001

(51) Int. Cl. G09G 5/00

(52) U.S. Cl. 345/2.1

(57) ABSTRACT

A communications system for airplane passengers includes a plurality of communications units fixedly mounted onboard an airplane. Each of the communications units is adapted to be operated by an associated passenger and may perform digital image viewing and/or scanning functions. At least one processor may be operatively connected to one or more image data receiver(s), a scanner, and a video screen. At least one remote connection device may also be provided which is adapted to connect each of the communications units to a remote location such as the Internet.

### FIELD OF THE INVENTION

The present invention relates generally to communications systems on airplanes for passenger use, and more particularly to a communications system having a personalized communications unit for each airplane passenger.

### BACKGROUND OF THE INVENTION

Those who travel on an airplane, such as vacationers and business travelers, often like to occupy their time on the airplane with personal and/or business-related tasks. For example, a vacationer may want to review information on his or her destination or view photos taken on the trip. Business travelers may need to fax documents or E-mail clients and associates.

For most of the flight, the allotted personal space for each airplane passenger is limited to his or her seat and surrounding area, including the seatback of the passenger directly in front of him or her. Due to these space limitations as well as airline restrictions on carry-on luggage, a passenger cannot always bring onto the airplane all of the equipment he or she needs to perform desired tasks. For example, many passengers bring notebook-type computers and possibly portable accessories onto the airplane. However, such computers and accessories can take up quite a bit of a passenger's extremely limited personal space. Some accessories, such as, for example, portable scanners, may be very difficult for an airplane passenger to effectively operate. Furthermore, portable accessories are oftentimes of a lower quality than their desktop equivalents.

Many commercial airplanes have personal video screens on board so that each passenger may view video media such as movies, airplane safety information, and the like. These video screens may be located, for example, in a seatback for use of the passenger behind that particular seat. The media displayed on the video screens is transmitted from a central location on the airplane, and its content is the same for each passenger Thus, the video screens are not truly “personal”, i.e., a passenger typically has no control over what is displayed on his or her video screen. A need therefore exists for a communications system having personalized communications units which may be utilized by each passenger on an airplane. The term “passenger” as used throughout this application refers to all persons on an airplane, including not only ticketed passengers but also crew members.

### SUMMARY OF THE INVENTION

The present invention is directed to a communications system for airplane passengers including a plurality of communications units fixedly mounted onboard an airplane (e.g., within seatbacks). Each of the communications units is adapted to be operated by an associated passenger and may perform digital image viewing and/or scanning functions, as well as connect to a remote location such as the Internet.

For the digital image viewing functions, the communications unit 14 may comprise at least one receiver adapted to receive image data from a digital camera and display the image data on a video screen. The receiver may be, for example, a digital camera memory card reader adapted to receive a memory card from a passenger's digital camera, an infrared receiver adapted to communicate with an infrared transmitter on a digital camera, and/or a radio signal receiver adapted to communicate with a radio signal transmitter on a digital camera. A processor is operatively connected to the receiver and video screen, and control apparatus may be provided which is adapted to control the image data on the video screen.

The communications unit 14 may also (or alternatively) comprise a scanner adapted to scan a document and display a scanned image of the document on a video screen. The scanner may be a conventional sheet-fed scanner having at least one input/output port, a driving mechanism positioned adjacent to the port which is adapted to drive the document into and out of the port, and a scanning module operatively connected to a processor. A PC connection device may be included which connects the scanner to a passenger's personal computer. Control apparatus may also be provided which is adapted to control the scanned image of the document on the video screen.

For communications units with either or both the digital image viewing and the scanning functions, a remote connection device may be provided which is adapted to connect each of the communications units to a remote location. The processor(s) and/or remote connection device(s) may be embodied within a central processing unit connected to all of the communications units.

A method for providing a personalized communications unit for each passenger on an airplane is also disclosed.

### BRIEF DESCRIPTION OF THE DRAWINGS

FIG. 1 is a perspective, cutaway view of an airplane with the communications system for airplane passengers of the present invention;

FIG. 2 is a front elevational view of an airplane seatback with an exemplary communications unit of the present invention adapted to perform both digital image viewing and scanning functions;

FIG. 3 is a sectional view of the airplane seatback and communications unit of FIG. 2 illustrating the digital image viewing functions in detail;

FIG. 4 is a sectional view of the airplane seatback and communications unit of FIG. 2 illustrating the scanning functions in detail; and

FIG. 5 is a schematic illustration of the communications system of FIG. 1 connected to a central processing unit.

### DETAILED DESCRIPTION OF THE INVENTION

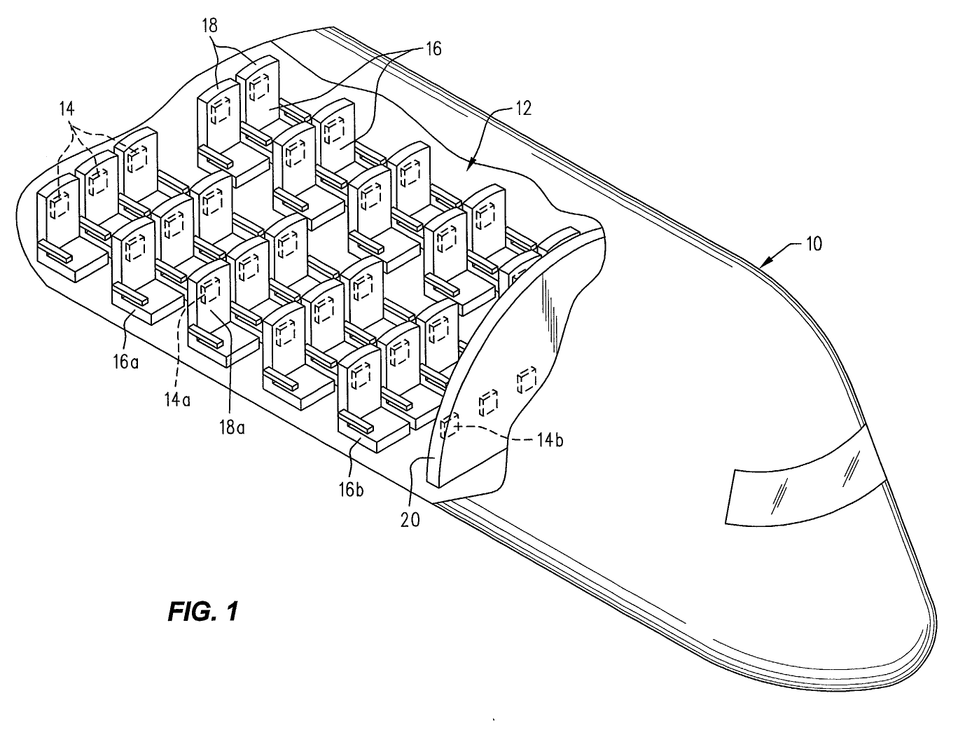

As shown in FIG. 1, the communications system 12 of the present invention may comprise a plurality of communications units 14 fixedly mounted onboard an airplane 10. Each of the communications units 14 are adapted to be operated by an associated passenger (not shown) in his or her seat 16. For example, as shown in FIG. 1, a first plurality of communications units (e.g., 14a) may be fixedly mounted within the airplane seatbacks (e.g., 18a) for use of the passenger in the seat facing the seatback (e.g., 16a). For those passengers not facing seatbacks 18, for example the seats (e.g., 16b) facing the bulkhead 20, communications units (e.g., 14b) may be located elsewhere, such as, for example, within the bulkhead 20 as shown. While it is contemplated that the seatbacks 18 are the most preferable location for the first plurality of communications units 14, alternative locations may be utilized. For example, a communications unit may flip up from an armrest or extend from the ceiling above the passenger. In this manner, each communications unit (e.g., 14a) is located within reach of an associated passenger seated in his or her seat (e.g., 16b), but does not occupy or reduce any of the passenger's personal space.

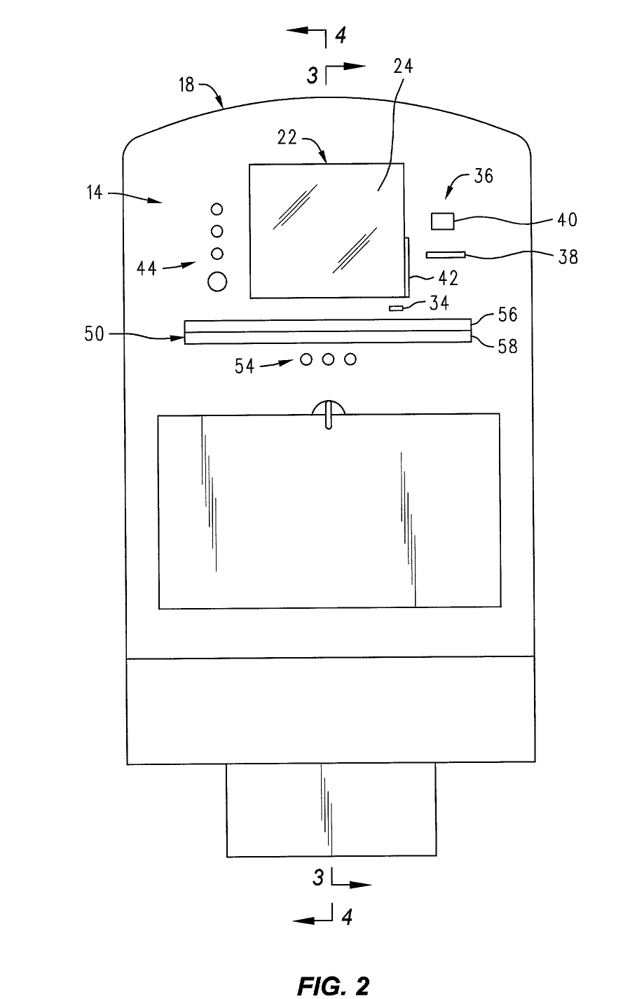

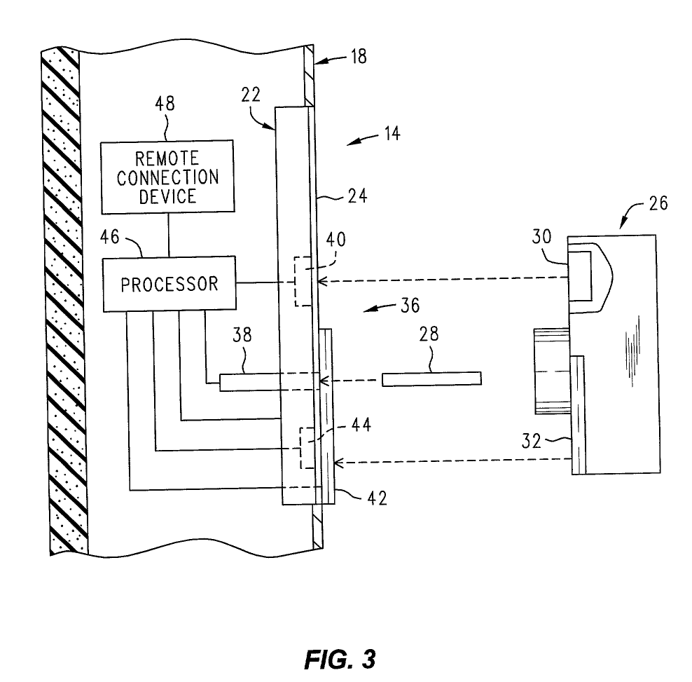

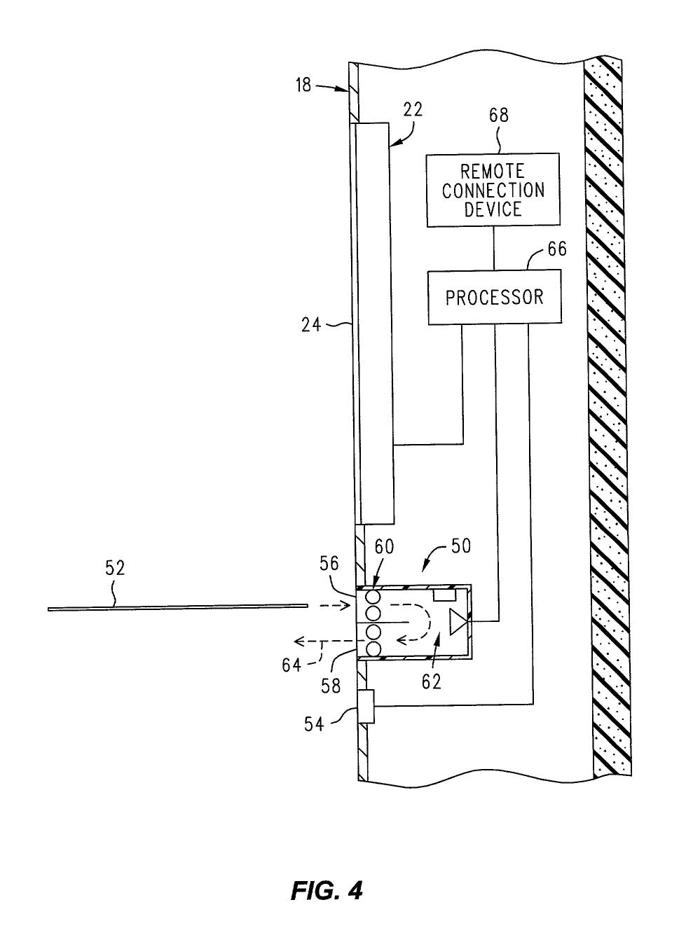

The communications system 12 of the present invention may provide digital image viewing and scanning functions in combination, or only one of these functions. FIG. 2 illustrates a communications unit 14 mounted within an airplane seatback 18 which includes both of these functions. FIGS. 3 and 4 show each of the functions in more detail. Regardless of the functions performed, the communications unit 14 may utilize an existing video monitor 22 having a video screen 24. Alternatively, each communications unit 14 may comprise its own video monitor 22. In addition (or alternatively), each communications unit 14 may comprise a PC connection device 34 such as a USB, “Bluetooth” or infrared (“IR”) port which allows a passenger to connect his own notebook-type computer to the PC connection device 34 in order to utilize the video screen, modem, portable device, etc., on the passenger's notebook-type computer.

It is to be understood that the communications system 12 of the present invention may be utilized on any airplane or section thereof, and communications units 14 may be provided in any desired combination. For example, communications units 14 may be provided for all the passengers on an airplane, only for the first class and/or business passengers, only for passengers seated behind seatbacks, etc.

As shown in FIGS. 2 and 3, for the digital image viewing functions, the communications unit 14 may comprise at least one receiver 36 adapted to receive image data from a passenger's digital camera 26 (FIG. 3) and display the image data on a video screen 24. The receiver 36 may comprise, for example, a digital camera memory card reader 38 which is adapted to receive a memory card 28 (FIG. 3) from a digital camera 26. The receiver 36 may also (or alternatively) comprise an infrared receiver 40 adapted to communicate with an infrared transmitter 30 (FIG. 3) on a digital camera 26. The receiver 36 may also (or alternatively) comprise a radio signal receiver 42 adapted to communicate with a radio signal transmitter 32 (FIG. 3) on a digital camera 26. The radio signal receiver 42 and transmitter 32 may incorporate the technology known as “Bluetooth” (see www.bluetooth.com).

The communications unit 14 may further comprise a control apparatus 44 (FIG. 2) operatively connected to the video screen 24 which is adapted to control the image data on the video screen 24. The control apparatus 44 may include buttons, toggles, or the like, which allow a passenger to perform digital image viewing functions such as, for example, scrolling through the digital images, rotating the images, purchasing prints of the images from an online service, faxing or e-mailing the images. The control apparatus 44 may be located near the video screen 24 as shown in FIG. 2, or may alternatively be located, for example, in the passenger's armrest. The communications unit 14 may also utilize existing controls such as the volume control buttons typically located on a passenger's armrest. For example, the volume control buttons may be operatively connected to the video screen 24 and adapted to scroll through the digital image data received by the receiver 36.

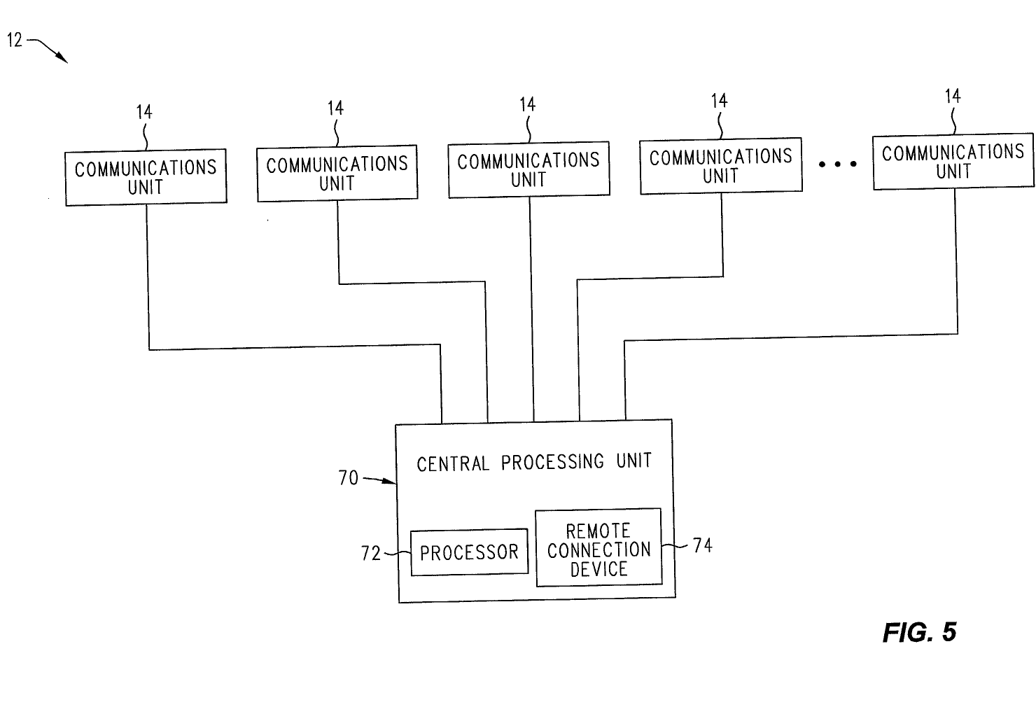

As schematically shown in FIG. 3, the communications unit 14 may also comprise an internal processor 46 operatively connected to the video screen, receiver 36, and control apparatus 44 (shown in dashed lines in FIG. 3). The internal processor 46 may be a standard processor adapted to process the image data and display it on the video screen 24. The communications unit 14 may further comprise a remote connection device 48 which is adapted to connect each of the communications units 14 to a remote location such as, for example, the Internet, a remote server, and the like. The remote connection device 48 may be, for example, a satellite modem, radio transmitter, or the modem which is connected to a preexisting telephone in the airplane seatback. The remote connection device 48 allows a passenger to send the digital images via the Internet, E-mail, or the like to relatives, friends, or any desired recipient. The remote connection device 48 also allows a passenger to perform other functions such as downloading and viewing information on his/her destination, sending E-mail messages, etc. Alternately, as shown in FIG. 5 and described in further detail below, the communications unit 14 may be connected to a central processing unit 70 which has a processor 72 and remote connection device 74 for use of all the passengers individually through their communications unit 14.

For the scanning functions (FIGS. 2 and 4), the communications unit 14 may comprise a scanner 50 adapted to scan a document 52 and display a scanned image of the document 52 on the video screen 24. The scanner 50 may have a separate control apparatus 54 associated therewith as shown in FIGS. 2 and 4, or in communication units 14 which comprise both scanning and digital image viewing functions, the control apparatus 54 for the scanning functions may be partially or fully incorporated into the control apparatus 44 for the digital image viewing functions. The control apparatus 54 is operatively connected to the video screen 24 and is adapted to control the scanned image of the document 52 on the video screen. For example, the control apparatus may allow a passenger to perform such functions as scrolling through the scanned images of documents (e.g., 52) sent through the scanner 50, selecting and manipulating an entire image or portions of the image, as well as but not limited to enhancing, rotating, modifying or annotating the image. Again, the communications unit 14 may also utilize existing controls such as the volume control buttons typically located on a passenger's armrest. For example, the volume control buttons may be operatively connected to the video screen 24 and adapted to scroll through the scanned images of documents (e.g., 52) sent through the scanner 50.

Referring to FIGS. 2 and 4, the scanner 50 may be any conventional scanner known in the art, such as, for example a sheet-fed scanner as shown in FIGS. 2 and 4, which is adapted to be mounted in a relatively small space such as an airplane seatback 18 (FIG. 1) Alternately, the scanner 50 may be a small portable scanner (not shown) which docks into the seatback 18. As schematically shown in FIGS. 2 and 4, the scanner 50 may comprise at least one port, e.g., an input port 56 and an output port 58, and a driving mechanism 60 positioned adjacent to the port 56, 58. The driving mechanism 60 may comprise, for example, a plurality of motor-driven rollers which are adapted to grasp the document 52 from the input port 56, send it past a scanning module 62 (e.g., CCD and light source), and then eject the document 52 through the output port 58. A paper guide (not shown) or the like may also be provided so that the document 52 follows a proper scanning path. An exemplary scanning path 64 is indicated by dashed lines and arrows in FIG. 4.

The communications unit 14 may further comprise an internal processor 66 operatively connected to the video screen 24, scanner 50, and control apparatus 54. The internal processor 66 may be a standard processor adapted to process the scanned image of the document 52 and display it on the video screen 24. The communications unit 14 may further comprise a remote connection device 68 which is adapted to connect each of the communications units 14 to a remote location such as, for example, the Internet, a remote server, and the like. The remote connection device 68, may be, for example, a satellite modem, radio transmitter, or the modem which is connected to a pre-existing telephone in the airplane seatback. The remote connection device 68 allows a passenger to send the scanned image of the document 52 via the Internet, E-mail, or the like to business associates or any other desired recipient, as well as perform other functions via the Internet or a remote computer.

In communication units 14 which comprise both scanning and digital image viewing functions, the internal processors 46, 66 and/or remote connection devices 48, 68 may be combined so that a single processor and/or a single connection device services both functions.

Alternately, as noted above and shown schematically in FIG. 5, a plurality of communications units 14 (adapted to perform either or both scanning and/or digital imaging viewing functions) may be connected to a central processing unit 70. While each of the communications units 14 are located in the passenger seating area as described above (i.e., within seatbacks 18 and/or the bulkhead 20, FIG. 1), the central processing unit 70 may be located in any convenient location on the airplane, such as, for example, with the central PA, audio and video equipment on the airplane 10. The central processing unit 70 may comprise a processor 72 which processes data as described above for each of the communications units 14 individually. The central processing unit 70 may also comprise a remote connection device 72 such as, for example, a satellite modem, radio transmitter, or and/or connection to the airplane's central communications system, which is adapted to individually connect each of the communications units 14 to a remote location such as the Internet. Alternatively, the central processing unit 70 may include only the processor 72, with each of the communications units 14 comprising its own remote connection device (48, FIG. 3; 68, FIG. 4). By connecting each of the communications units 14 to a central processing unit 70, each of the communications units 14 are therefore connected. This allows passengers to send digital images and/or scanned images of documents from their communications unit to another passenger's communications unit.

With reference to FIGS. 1-5, the present invention is also directed to a method for providing a personalized communications unit 14 for each passenger on an airplane 10. The method comprises the initial step of providing each passenger with a video screen 24, at least one receiver 36 adapted to receive image data from a digital camera 26 and display the image data on a video screen 24, and a scanner 50 adapted to scan a document 52 and display a scanned image of the document 52 on a video screen 24. The next step involves connecting the personalized communications unit 14 to a central processing unit 70 comprising a processor 72. Either the personalized communications unit 14 or the central processing unit 70 may also comprise a remote connection device 48, 68, 70.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

We claim:

1. A communications system, comprising:
a) a plurality of communications units fixedly mounted onboard an airplane, each of said communications units being adapted to be operated by an associated passenger to perform digital image viewing functions, whereby each of said communications units comprises at least one receiver adapted to receive image data from a digital camera and display said image data on a video screen; and
b) at least one processor operatively connected to said at least one receiver and said video screen.

2. The communications system of claim 1 wherein a first plurality of said plurality of communications units are fixedly mounted within seatbacks on said airplane.

3. The communications system of claim 1, each of said communications units further comprising control apparatus operatively connected to said at least one processor and said video screen which is adapted to control said image data on said video screen.

4. The communications system of claim 1, each of said communications units further comprising a video monitor, said video monitor comprising said video screen.

5. The communications system of claim 1 wherein said at least one receiver is a digital camera memory card reader adapted to receive a memory card from a digital camera.

6. The communications system of claim 1 wherein said at least one receiver is an infrared receiver adapted to communicate with an infrared transmitter on a digital camera.

7. The communications system of claim 1 wherein said at least one receiver is a radio signal receiver adapted to communicate with a radio signal transmitter on a digital camera.

8. The communications system of claim 1 further comprising at least one remote connection device adapted to connect each of said communications units to a remote location.

9. The communications system of claim 8 further comprising a central processing unit operatively connected to said plurality of communications units, wherein said at least one processor and said at least one remote connection device are located within said central processing unit.

10. The communications system of claim 8 wherein said at least one processor and said at least one remote connection device are located within each of said communications units.

11. The communications system of claim 8 wherein said at least one remote connection device is adapted to connect each of said communications units to the Internet.

12. A communications system, comprising:
a) a plurality of communications units fixedly mounted onboard an airplane, each of said communications units being adapted to be operated by an associated passenger to perform scanning functions, whereby each of said communications units comprises a scanner adapted to scan a document and display a scanned image of said document on a video screen;
b) at least one processor operatively connected to said scanner and said video screen; and
c) at least one remote connection device adapted to connect each of said communications units to a remote location.

13. The communications system of claim 12 wherein a first plurality of said plurality of communications units are fixedly mounted within seatbacks on said airplane.

14. The communications system of claim 12, each of said communications units further comprising apparatus operatively connected to said at least one processor and said video screen which is adapted to control said scanned image on said video screen.

15. The communications system of claim 12, each of said communications units further comprising a video monitor, said video monitor comprising said video screen.

16. The communications system of claim 12, each of said communications units further comprising a PC connection device adapted to connect said scanner to a passenger's personal computer comprising said video screen.

17. The communications system of claim 12, said scanner comprising:
a) at least one port adapted to receive and eject a document;
b) a driving mechanism positioned adjacent to said port which is adapted to drive a document into and out of said port; and
c) a scanning module operatively connected to said at least one processor.

18. The communications system of claim 12 further comprising a central processing unit operatively connected to said plurality of communications units, wherein said at least one processor and said at least one remote connection device are located within said central processing unit.

19. The communications system of claim 12 wherein said at least one processor and said at least one remote connection device are located within each of said communications units.

20. The communications system of claim 12 wherein said remote connection device is adapted to connect each of said communications units to the Internet.

21. A communications system, comprising:
a) a plurality of communications units fixedly mounted onboard an airplane, each of said communications units being adapted to be operated by an associated passenger to perform digital image viewing and scanning functions, whereby each of said communications units comprises:
i) at least one receiver adapted to receive image data from a digital camera and display said image data on a video screen; and
ii) a scanner adapted to scan a document and display a scanned image of said document on a video screen;
b) at least one processor operatively connected to said at least one receiver, said scanner, and said video screen; and
c) at least one remote connection device adapted to connect said communications units to a remote location.

22. A communications system, comprising:
a) a plurality of communications units fixedly mounted onboard an airplane, each of said communications units comprising:
i) at least one receiver adapted to receive image data from a digital camera and display said image data on a video screen;
ii) a scanner adapted to scan a document and display a scanned image of said document on a video screen; and
b) at least one processor operatively connected to said at least one receiver and said video screen.
